(19) United States
(12) Patent Application Publication
(10) Pub. No.: US 2023/0417561 A1
(43) Pub. Date: Dec. 28, 2023

(54) Method and System for Operating a Fleet of Vehicles

(71) Applicant: Bayerische Motoren Werke Aktiengesellschaft, Muenchen (DE)

(72) Inventors: Florian DANDL, Wolnzach (DE); Arslan Ali SYED, Muenchen (DE)

(21) Appl. No.: 18/036,441

(22) PCT Filed: Dec. 21, 2020
(86) PCT No.: PCT/EP2020/087389

§ 371 Date: May 11, 2023

(51) Int. Cl. G01C 21/34

(52) U.S. Cl. CPC G01C 21/3438; G01C 21/3461

(57) ABSTRACT

Methods and systems for operating a fleet of vehicles are provided. An operating area of the fleet of vehicles is provided. The operating area is divided into a plurality of regions. An imbalance is determined for each region based on a vehicle supply and a vehicle demand of the region. The imbalances of each region are converted into respective imbalance densities. Fleet optimization is performed based on the respective imbalance densities to reduce an overall vehicle imbalance in the operating area.

### BACKGROUND AND SUMMARY OF THE INVENTION

The present disclosure relates to a method and system for operating a fleet of vehicles. Examples of the present disclosure particularly relate to an efficient repositioning and/or allocation of vehicles using a density-based distribution model.

With the increasing use of smartphones and the need to share resources, Mobility on Demand (MOD) applications such as Ride Hailing (RH) and Ride Sharing (RS) services have emerged and their market has been growing fast in the recent years all over the world. In RH services, the user requests a vehicle for a trip from a pickup location to a dropoff location. In RS services, a single vehicle can combine multiple user requests into a single trip. For both RH and RS, Mobility Service Providers (MSP) have to assign the incoming user requests to suitable vehicles.

After serving a customer, vehicles in a Mobility on Demand (MOD) service potentially end up in areas with little demand, causing an imbalance of vehicle supply and vehicle demand. Therefore, a vehicle utilization is often low.

In view of the above, new methods and systems for operating a fleet of vehicles, that overcome at least some of the problems in the art are beneficial.

In light of the above, a method for operating a fleet of vehicles and a system for operating a fleet of vehicles are provided.

It is an object of the present disclosure to improve vehicle utilization, in particularly in a Mobility on Demand (MOD) service. In particular, it is an object of the present disclosure to provide an efficient vehicle utilization and/or vehicle routing and thereby reduce energy consumption and/or vehicle emissions, such as carbon dioxide emission.

Further aspects, benefits, and features of the present disclosure are apparent from the claims, the description, and the accompanying drawings.

According to an independent aspect of the present disclosure, a method for operating a fleet of vehicles is provided. The method includes providing an operating area of the fleet of vehicles, wherein the operating area is divided into a plurality of regions; determining, for each region, an imbalance based on a vehicle supply and a vehicle demand of the region; converting the imbalances of each region into respective imbalance densities; and performing fleet optimization based on the imbalance densities to reduce an overall vehicle imbalance in the operating area.

Accordingly, an optimization is performed based on imbalance densities to reduce an overall vehicle imbalance in the operating area. In particular, a reachability function-based method is used that coherently builds a relation among all regions in the form of a density of a measured quantity. This is used to calculate the imbalance density of the whole operational area; based on the imbalance density, one can derive e.g. a repositioning formulation that significantly reduces the overall vehicle imbalances.

Thereby, vehicle utilization, in particularly in a Mobility on Demand (MOD) service, can be improved. The improved vehicle utilization enables an efficient vehicle routing and thereby a reduction of energy consumption and/or vehicle emissions.

The operating area is divided into a plurality of regions. The plurality of regions can be suitably selected e.g. based on city districts, vehicle demand history, etc.

Preferably, the imbalance for a respective region is determined by subtracting the vehicle supply from the vehicle demand of said region, or by subtracting the vehicle demand from the vehicle supply of said region. An example for the calculation of the imbalance can be found in the detailed description.

Preferably, the vehicle demand for a region is determined based on forecast information. The forecast information can be based on historical information of the vehicle demand. The vehicle demand may vary e.g. based on day (weekday, weekend), time of year (summer, winter, etc.), time of day (morning, night, etc.), weather (cold, warm, rain, etc.), etc.

Preferably, the step of converting the imbalances of each region into respective imbalance densities uses a Kernel function, in particular a 2D Kernel function.

Preferably, the fleet optimization is based on multi-objective optimization. For example, the fleet optimization is based on a lexicographic method (e.g. Prioritized Balanced density, PBD) or a weighted sum method.

Preferably, in a non-limiting example, the method can be applied to the relocation of one or more vehicles of the fleet of vehicles from its present region to another region based on the fleet optimization. For example, at least one vehicle or a plurality of vehicles or even all vehicles can be relocated from its/their present region to another region based on the fleet optimization. Additionally, or alternatively, at least one vehicle or a plurality of vehicles or even all vehicles cannot be relocated from its/their present region to another region based on the fleet optimization. In other words, a result of the fleet optimization can be to not move vehicles if it is not necessary (e.g. in order to save vehicle-km and/or emissions).

Preferably, the method further includes implementing one or more flow restrictions. In some examples, the one or more flow restrictions are selected from the group including limiting (e.g. preventing or excluding) a relocation of vehicles from vehicle deficient regions to vehicle surplus regions; and limiting (e.g. preventing or excluding) a relocation of vehicles from vehicle surplus regions to other vehicle surplus regions.

Preferably, the method further includes determining a travel path for at least one vehicle, in particular a plurality of vehicles, of the fleet of vehicles based on the fleet optimization. The travel path may be a geographical path. For example, map data can be used to route the exact geographical path though the map.

Preferably, the method further includes navigating and/or controlling the at least one vehicle, in particular the plurality of vehicles, according to the determined travel path(s). Accordingly, a central control of the fleet can be provided.

Preferably, the vehicles of the fleet of vehicles are configured for autonomous driving. For example, the vehicles are autonomous vehicles, such as autonomous taxis. Autonomous vehicles can be configured for driverless driving, where the vehicle can automatically handle all situations like a human driver during the entire journey; a driver is generally no longer required.

However, the present disclosure is not limited to autonomous driving and may be applied to manual driving by a human driver. For example, the method may include a step of providing instructions, e.g. the determined travel path(s), to a vehicle or a device, such as a mobile device, of a human driver.

The term mobile device includes in particular smartphones, but also other cell phones, personal digital assistants (PDAs), tablet PCs, notebooks, smart watches and all current and future electronic devices that are equipped with technology for communication with other devices.

The term vehicle includes passenger cars, trucks, buses, mobile homes, motorcycles, etc., which serve to transport people, goods, etc. In particular, the term includes motor vehicles for the transport of persons.

Examples are also directed at systems for carrying out the disclosed methods and include system aspects for performing each described method aspect. These method aspects may be performed by way of hardware components, a computer programmed by appropriate software, by any combination of the two or in any other manner. Furthermore, examples according to the invention are also directed at methods for operating the described system. It includes method aspects for carrying out every function of the system.

According to another independent aspect of the present disclosure, a machine-readable medium is provided. The machine-readable medium includes instructions executable by one or more processors to implement the method for operating a fleet of vehicles of the examples of the present disclosure.

The (e.g., non-transitory) machine readable medium may include, for example, optical media such as CD-ROMs and digital video disks (DVDs), and semiconductor memory devices such as Electrically Programmable Read-Only Memory (EPROM), and Electrically Erasable Programmable Read-Only Memory (EEPROM). The machine-readable medium may be used to tangibly retain computer program instructions or code organized into one or more modules and written in any desired computer programming language. When executed by, for example, one or more processors such computer program code may implement one or more of the methods described herein.

According to an independent aspect of the present disclosure, a system for operating a fleet of vehicles is provided. The system includes one or more processors; and a memory (e.g. the above machine-readable medium) coupled to the one or more processors and comprising instructions executable by the one or more processors to implement the method of the examples of the present disclosure.

The method allows to reduce processing times and the use of processing resources.

Preferably, the system is a server of a Mobility Service Provider, MSP.

### BRIEF DESCRIPTION OF THE DRAWINGS

FIG. 1 shows a flowchart of a method for operating a fleet of vehicles according to examples described herein; and

FIG. 2 shows a flow of a reachability function-based strategy according to examples described herein.

### DETAILED DESCRIPTION

Reference will now be made in detail to the various examples of the disclosure, one or more examples of which are illustrated in the figures. Within the following description of the drawings, the same reference numbers refer to same components. Generally, only the differences with respect to individual examples are described. Each example is provided by way of explanation of the disclosure and is not meant as a limitation of the disclosure. Further, features illustrated or described as part of one example can be used on or in conjunction with other examples to yield yet a further example. It is intended that the description includes such modifications and variations.

After serving a customer, vehicles in a Mobility on Demand (MOD) service potentially end up in areas with little demand, causing an imbalance of vehicle supply and demand. Therefore, vehicle utilization is often low.

The examples of the present disclosure overcome the above drawback by providing a density-based distribution approach. In particular, an optimization is performed based on imbalance densities to reduce an overall vehicle imbalance in the operating area. A reachability function-based method is used that coherently builds a relation among all regions in the form of a density of a measured quantity. This is used to calculate the imbalance density of the whole operational area; based on the imbalance density, one can derive e.g. a repositioning formulation that significantly reduces the overall vehicle imbalances.

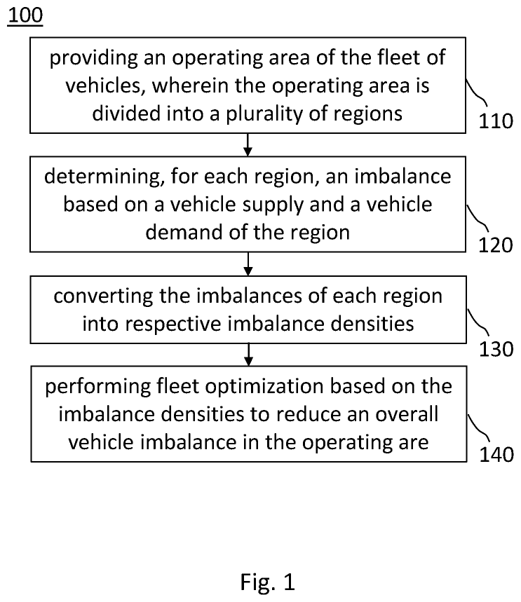

FIG. 1 shows a flowchart of a method 100 for operating a fleet of vehicles according to examples described herein.

The method 100 includes providing an operating area of the fleet of vehicles, wherein the operating area is divided into a plurality of regions (step 110); determining, for each region, an imbalance based on a vehicle supply and a vehicle demand of the region (step 120); converting the imbalances of each region into respective imbalance densities (step 130); and performing fleet optimization based on the imbalance densities to reduce an overall vehicle imbalance in the operating area (step 140).

In some examples, the method 100 can include steps to navigate and/or control the vehicles according to travel paths which have been determined based on the density-based optimization. For example, the method 100 can include steps to provide instructions to autonomous vehicles to transport users from their respective origin to their respective destination.

The following sections provide an extensive and detailed overview of the above general approach.

### 1. Service Definitions and Problem

This section presents the formal definitions, assumptions and the dynamic MOD service problems focused in the present disclosure.

### 1.1 Studied Mobility on Demand Service Definition

The studied RH service has the following characteristics:
Each customer i dynamically requests a ride at time tᵢ via an app providing the pickup pᵢ and the drop-off dᵢ locations.
A customer can only be picked up within the maximum waiting time, ΔTₘₐₓ, starting from tᵢ.
Any customer that cannot be picked up before ΔTₘₐₓ+tᵢ is rejected.
A customer pickup delay is defined as the difference between the actual arrival time of the vehicle at pᵢ and tᵢ.
The fleet consists of homogeneous vehicles (AVs) that do not need recharging or refuelling.
The assignment of vehicles to customers is controlled by a central fleet controller (FC).
A fleet of fixed size n.
Only a single customer request can be served at a time.

### 1.2 Service Quality Measurement

The assignment of vehicles to customer requests is a stochastic dynamic vehicle routing problems (SDVRP) problem. The overall performance or effectiveness of a specific strategy can only be evaluated after all the customer requests are received. Therefore, one can quantify the service quality in terms of total monetary profit based on travelled distances as overall objective of the dynamic RH scenario. One can study a system, in which every served customer i must pay a fixed cost ƒ and a variable cost of f^{D} per kilometer for the distance dᵢ^{pd} between locations pᵢ to dᵢ. On the cost side, one can consider the per kilometre cost c^{D} as well as fix costs c^{F} (total value for the simulation period for e.g. leasing and insurance) for the vehicles. One can also assume that every non-served customer might not use the service again in future, leading to non-popularity of the service. Therefore, one can also use a constant cost ξ for each customer not served.

With the above definitions, for a set of all the served customer requests R^{s}, unserved customers R^{ns} and vehicle fleet V, the overall profit of the service is given by expression (1):

$${\sum }_{i ∈ {R}^{s}} ( ζ + {f}^{D} \cdot {d}_{i}^{pd} ) - {\sum }_{v ∈ V} ( {c}^{D} \cdot {d}_{v} + {c}^{F} ) - {\sum }_{i ∈ {R}^{n s}} ξ$$

where dᵥ is the total distance travelled by vehicle v.

### 1.3 Vehicle Assignment Problem

One can batch the new requests for x seconds (e.g. 30 seconds or more or less) before assigning them to the vehicles. The FC solves an optimization problem on the batched requests, which is referred to as vehicle control optimization (VCO). Since the problem is SDVRP and the overall objective of FC is to maximize the profit in expression (1), the objective function in VCO can be different from expression (1) with additional terms for statistical data. However, one can keep the objective in VCO the same as the actual profit for the sake of simplicity. Thus, the batch optimization problem is described as follows.

The FC first checks for availability of the vehicles, i.e. the time and the position when and where a vehicle could be assigned a new task. If the vehicle is already serving some customers, then it finds the drop-off time and location of the last customer in the vehicle's path. Then the VCO maximizes expression (1) for the batched requests R_{b} with the following constraints:
Each request is served at most by one vehicle.
At most one pick-up assigned to each vehicle.
For a served request i the pickup time is before ΔTₘₐₓ+tᵢ.

One can assume that any request that could not be matched with a vehicle in the current batch, will be most likely not matched in the future batches as well. Since vehicles en route to drop-off customers are viewed as available, this assumption would be invalid only if another customer was both picked up and dropped off within this time frame and the respective vehicle would be very close to the request's pick-up location. For simplicity, all the unassigned requests are immediately rejected and removed from the future batches.

### 1.4 General Repositioning Problem

In a dynamic MOD scenario, the spatio-temporal distributions of customer demand and vehicle availability play a major role in improving the overall service quality. After dropping off a customer, vehicles might wait a long time before getting the next customers, despite the fact that there are many unserved customers in other parts of the city. Therefore, a general repositioning problem tries to minimize this supply and demand gap by routing the idle vehicles to areas with expected vehicle deficit. Ideally, a repositioning algorithm should consider every possible coordinate inside the city for this purpose. However, demand (and for larger forecast horizons supply as well) forecasts are usually not available on such a fine granularity, and dealing with an algorithm on such a level poses a significant computational challenge which will be discussed further below.

### 1.5 Region-Based Repositioning Problem

Typically, regions are introduced to aggregate demand and supply forecasts and to limit the possible destinations of vehicles to be repositioned in optimization problems. Let Z denote the set of all zones that represent a disjoint set cover of the operating area. Forecasts for both supply and demand are made within each zone for a temporal horizon ΔTₕ. The repositioning problem is solved periodically after every ΔTᵣ with weights ω_{z}∈W representing the imbalance of supply and demand for zone z∈Z.

For the calculation of ω_{z}, one can depend on the forecast information. One can count vehicles that will be available after dropping off a customer inside a region z positive and subtract the number of trips starting from z. One can use the difference of sets R_{z}⁺ and R_{z}⁻ representing the forecast customer drop-off and pick-up locations for ΔTₕ and zone z, respectively. Additionally, one can add V_{z}⁺, the idle vehicles in zone z, and V_{z}^{r}, the vehicles being sent to zone z in a previous repositioning cycle. Thus, ω_{z} is computed by expression (2):

ω_{z}=|V_{z}⁺|+|V_{z}^{r}|+|R_{z}⁺|−|R_{z}⁻|

Let surplus zones Z⁺⊆Z and deficiency zones Z⁻⊆Z represent the zones with positive and negative weights ω_{z}, respectively. Then the repositioning algorithm called at time t returns a flow matrix u^{(t)}∈I^{|Z}^{⁺}^{|×|Z}^{^{−}}^{|} representing the number vehicles need to be repositioned from vehicle surplus to vehicle deficiency zones. Note that the repositioning algorithms are allowed to only reposition idle vehicles V_{z}⁺ from zone z.

ω_{z} represents the expected vehicle imbalance in zone z within the time horizon ΔTₕ if the operator does not reposition. Most region-based repositioning algorithms assume that a single repositioning vehicle changes the weight imbalance by one (expression 3):

$${ρ}_{z} = {ω}_{z} + {\sum }_{i ∈ Z} {u}_{iz} - {\sum }_{j ∈ Z} {u}_{zj}$$

where ρ_{z} is the post state of the repositioning decision process. This is a simplification as the vehicle will only be available for a part of the time horizon ΔTₕ or not at all if the distance between regions i and z is too large to be reached within ΔTₕ.

In the end, explicit repositioning demands, i.e. send vehicle v to position x, have to be derived from the region-based flow matrix u^{(t)}. There are several ways to do that. In this study, the set of all trips originating from zone z is created. Then, a greedy algorithm randomly picks the next trip. Let j be the destination zone of this trip. The algorithm then searches for the idle vehicle in zone k, which has the shortest mean distance to nodes within zone j and assigns this vehicle to drive to a randomly drawn node within zone j. The centroid of j is not chosen as destination in order to increase the spread of vehicles and reduce clumping of vehicles in the centroids.

In the subsequent section, a method is derived that computes the repositioning flow matrix u^{(t)} considering a spatially correlated vehicle imbalances. Henceforth, the superscript in flow matrix u^{(t)} is dropped, since it is clearly understood that a particular instance of repositioning problem is solved at time t.

### 2. Methodology

This section presents the solution approaches used in the present disclosure. It starts with a brief description of the KDE, then states a general KDE based repositioning problem and discusses the involved computational challenges before introducing an approximate KDE based repositioning strategy. Finally, it introduces KDE based KPIs to evaluate repositioning assignments.

### 2.1 Kernel Density Estimation (KDE)

KDE is a non-parametric probability density function (pdf) estimator. KDE tries to automatically adopt itself to the shape of the underlying density function. Let x₁, x₂, . . . xₙ∈ [symbol] be a set of independent data points drawn from an actual probability density function p(x), then a KDE is calculated as (expressions (4) and (5))

$$p ( x ) = \frac{1}{{NV}_{d}^{( k )} {h}^{d}} {\sum }_{i = 1}^{N} k ( x , {x}_{i} , h )$$

$$k ( x , {x}_{i} ; h ) = K ( \frac{x - {x}_{i}}{h} )$$

where K: [symbol] → [symbol] is a smooth kernel function, h>0 is the bandwidth for smoothness and xᵢ is a data point. V_{d}^{k} is a kernel- and dimension-dependent normalization factor so that the integral ∫\hat{p}(x)dx=1.

There are many smooth kernels that are generally used in KDE, e.g. triangular, Gaussian, triweights etc. However, one can interpret the kernel function in terms of an approximation to the maximum reachable distance by a single vehicle. Any vehicle located at the centre of the kernel will have the highest probability of serving a customer at the centre, that will become smaller as the Euclidean distance of the customer pickup location increases. Thus, in the present disclosure the simple triangular function is used, given as expression (6):

$$K ( x ) = \{ \begin{matrix}1 - ‖ x \text{?} , & if ‖ x \text{?} \leq 1 \\ 0 , & otherwise\end{matrix}$$

$$\text{?} \text{indicates text missing or illegible when filed}$$

One can use the Euclidean norm in the above equation, i.e. s=2, for which V_{d}^{(k)} is π/3.

### 2.2 Adopting KDE for Repositioning Problem

The fundamental usage of KDE is to estimate the underlying pdf of a dataset without any assumption that the pdf belongs to a parametric family. KDE adopts the shape of estimated pdf according directly from the data, making it a very useful tool for data drawn from complicated distributions. The most important parameter of a KDE, i.e. h, is usually calculated automatically using various approaches to reduce the asymptotic mean integrated square error (AMISE). The data centres and the overall spread of the estimated pdf is heavily dependent on the choice of bandwidth h (the spread of a single data point).

The motivation of using a KDE-inspired approach for the repositioning problem is to balance the distribution of available vehicles (supply) according to the customer distribution (demand), such that the maximum number of customers could be served with least VMTs. KDE seamlessly combines the impacts of neighbouring data points through kernels. Since the bandwidth h defines the spread of the kernel function, one can interpret it as an approximation of the maximum reachable (servable) distance of a single vehicle (customer request). Similarly, one can refer to the kernel function as reachability (servability) function for the vehicles (customer requests). This naturally eliminates the fundamental limitation of the region based repositioning approaches that treats each region separately without due regard to the proximity of other regions. However, using the above mentioned KDE formulation and approach, directly could lead to some issues as described below:
1. The major focus of the bandwidth selection algorithms in KDE is to find an h that would improve the estimate of the underlying probability density function of the random variable. Thus, in case of customer and vehicle geographical locations, it would only mean to estimate an h that would provide a good estimate of the probability density for generating the customer and vehicle locations. Such an h would not correspond with our interpretation of h as vehicles reachable distance.
2. The customer and vehicle data in a RH scenario are dynamic and thus the underlying density of their location is expected to change in every repositioning throughout the day and week and thus, the value of h derived from bandwidth estimation algorithms can vary significantly, which may lead to long-term inconsistent decisions.
3. Even for a single instance of the repositioning problem, the values of bandwidth h obtained from an algorithm might be significantly different for the customer and vehicle distributions. Thus, even if one repositions the idle vehicles to close the gap between the customer and vehicles KDE, the repositioned vehicles still may not serve the intended customer because of different bandwidths. For example, consider the case when customers and vehicles KDE has a bandwidth of 500 m and 2 km, respectively. The algorithm will falsely reposition very few vehicles assuming that the vehicles have a reachability of 2 km, which may not be applicable due to the average speed in the area of operation.
4. Since the KDE is normalized with the number of available data points (expression (4)) to make the integral unity, the scales of customers and vehicles KDE might be significantly different. For example, consider the case with 100 expected customers and 300 idle vehicles with KDEs calculated using expression (4). The algorithm would try to unnecessarily send high number of vehicles near the expected customers, as the customers KDE would be on similar scale as of idle vehicles KDE due to normalization.

To resolve issues 1 and 2 instead of using a data driven value of h calculated through bandwidth estimation algorithms, one can select h according to the network state (size of the operating area, average speed etc) and RH service quality (maximum waiting time). For issue 3, an issue can be caused by normalization of the KDE on the same scale such that ∫\hat{p}(x)dx=1 irrespective of the number points, which is usually required because KDE is estimating a pdf. However, for the present purpose, estimating a pdf is not as important as using a consistent scale for customer and vehicles. Thus expression (4) may by modified (expression (7)):

$$\overline{p} ( x ) = \frac{3}{π {h}^{d}} {\sum }_{i = 1}^{N} k ( x , {x}_{i} , h )$$

where k is the triangular kernel given in expression (6). The above equation does not represent a pdf, however, it has a useful property of ∫\hat{p}(x)dx=N. It represents the spatial density of the data points. If it is calculated for customer requests then it represents the demand density, and if it is calculated for the available vehicles then it represents the supply density.

If individual points are aggregated in a set of points {xᵢ}, then a weighted version of the above density function is given as (expression 8):

$$\overline{p} ( x ) = \frac{3}{π {h}^{d}} {\sum }_{i = 1}^{N} {w}_{i} k ( x , {x}_{i} , h )$$

with ∫\hat{p}(x)dx=Σᵢ^{N} ωᵢ. Since both expression 7 and expression 8 no more calculate a pdf, the approach is referred to as vehicle reachability function based repositioning (RFR).

### 2.3 Reachability Function Based Repositioning Strategy

This section presents the general version of RFR where it is assumed that the MSP has exact knowledge of the origins and destinations of the future customer requests within the forecast time horizon. In this section the exact customer and vehicle locations are directly used for calculating densities. The involved computational challenges for such formulation and the procedures that can be adopted to reduce the computational complexity are discussed.

Let p̅_{R}_{_{−}} and p̅_{R}_{₊} be densities calculated using expression 7 with bandwidth h for pick-up and drop-off locations, respectively. These locations describe demand and supply because vehicles are required at the pick-up locations and become available at drop-off locations. Assuming that an MSP knows the exact pick-up and drop-off locations of future customers, p̅_{R}_{_{−}} and p̅_{R}_{₊} are indicators for expected demand and supply of vehicles, respectively. Let x₁^{idle}, x₂^{idle}, . . . , x_{n,idle}^{idle}∈ [symbol] be the positions of idle vehicles and x₁^{r}, x₂^{r}, . . . , x_{n,r}^{r}∈ [symbol] ² be the points in the operating area where idle vehicles could be repositioned and become part of the vehicle supply. Note that multiple vehicles can be repositioned to the same point, assuming that the repositioned vehicle will park itself to the nearest free geographical position after reaching the destination. The formulated repositioning problem has multiple, conflicting objectives: the FC aims to reduce the demand-supply imbalance, i.e. the difference between the densities of demand and the available vehicles, while reducing the repositioning VMTs. Thus, the multi-objective repositioning problem is given as:

$${min}_{u} f ( u ) , g ( u ) \qquad ( 9 a )$$

$$s . t . \text{?} {u}_{ij} \leq 1 ∀ i ∈ \{ 1 , ... , {n}_{idle} \} \qquad ( 9 b )$$

$$g ( u ) = {\sum }_{i , j} {c}_{ij} {u}_{ij} \qquad ( 9 c )$$

$$f ( u ) = F ( {\underbrace{\begin{matrix}m & ( x , u ) + \text{?}\end{matrix}}}_{supply density} , {\underbrace{\text{?}}}_{demand density} ) \qquad ( 9 d )$$

$$\text{?} = {\underbrace{a \text{?} [ \text{?} , \text{?} , h ) \text{?} {u}_{ji} ]}}_{density of the repositioned vehicles} + {\underbrace{a \text{?} [ k ( x , \text{?} , h ) \text{?} ( 1 - {u}_{ij} ) ]}}_{density of the vehicles at original positions} \qquad ( 9 e )$$

$$\text{?} \text{indicates text missing or illegible when filed}$$

where

$$a = \frac{3}{π {h}^{2}} , u := ( {u}_{ij} ) ∈ {\{ 0 , 1 \}}^{{n}_{idle} \times {n}_{r}}$$

is a binary variables matrix for flow of idle vehicles from origins to repositioning points and C:=(cᵢⱼ)∈ [symbol] is the matrix of travelling costs. The function F: [symbol] → [symbol] is a metric for measuring the deviation between the two densities. Thus, expression 9d is the objective function for minimizing the difference between the customer demand and vehicle supply by reshaping the idle vehicle density. The constraint in expression 9b forces a maximum of one repositioning destination point to be assigned to each vehicle.

The formulation is a multi-objective optimization problem with n_{idle}·nᵣ decision variables and n_{idle} constraints. This problem could be large and difficult to solve depending on the number of idle vehicles and repositioning points inside the city. Furthermore, the optimization algorithm will have to repeatedly evaluate expression 9d. The values p̅_{R}_{_{−}} and p̅_{R}_{₊} could be calculated before the optimization process, but one will still have to evaluate expression 9e in each iteration of the solution process. Assume that one evaluates and saves the kernels in expression 9e on kₑᵥₐₗ equidistant points in the first iteration (that will still consume memory), the evaluation time of expression 9e will be still of O(nᵣkₑᵥₐₗn_{idle}). For considerable accuracy kₑᵥₐₗ has to be a large number, for example, for Manhattan with a distance of 50 m between each points kₑᵥₐₗ will be in order of 10⁵, and increases to 10⁶ for a distance of 10 m. Such a running time for the repositioning problem may be not practical especially for a dynamic RH scenario where it has to be solved periodically.

Therefore, even if an ideal forecast method could provide exact locations of the future customers, it would still be not feasible to use exact points for an exact RFR optimization approach. There could be two approaches to reduce the required computational effort of expression 9e. 1) In each iteration of the optimization, incrementally calculate the new densities. This can be done by subtracting the kernel contributions of only those kernels whose associated decision variables are changed, i.e. the inner loop of both terms in expression 9e. However, this is only beneficial for metaheuristic algorithms that have complete control on evaluation of objective functions. For mixed integer programming (MIP) solvers it would be difficult to use such method. 2) A more suitable and scalable approach is to use the binning technique that is also used for calculating KDE using FFT method for large data sets. This technique will be discussed in detail in the following section.

2.4 Reachability Function Based Repositioning with Regions

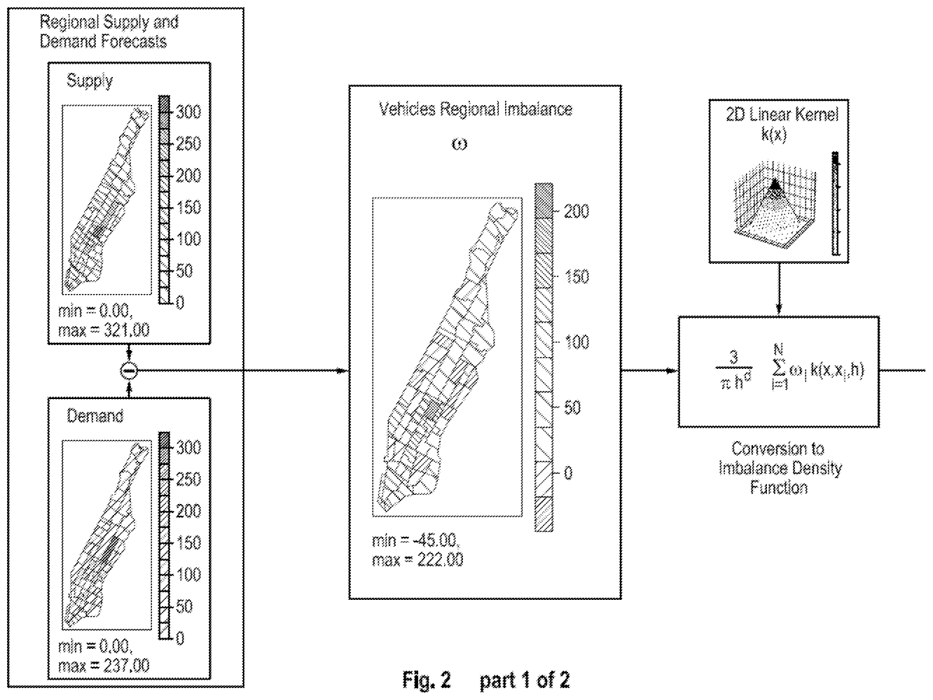

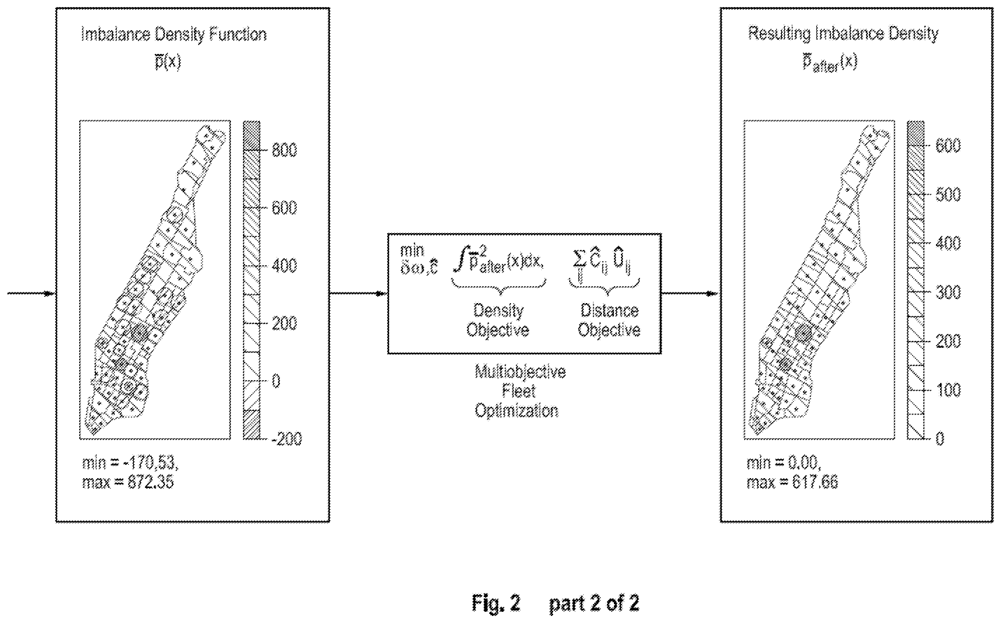

The formulation for the pre-defined regions is motivated by i) forecasts usually being available in an aggregated form and ii) the binning technique used for KDEs, in which the data points are sorted and distributed into bins with a weight assigned to each bin. After binning, the KDE is calculated either by using weighted KDE formulation or by multiplying the Fourier transform of the binned data with the Fourier transform of the kernel and then calculating inverse Fourier transform. One can use a similar approach for calculating RFR, but instead of using regular bin centres as the data points one can use centroids of pre-defined zones with arbitrary shapes. However, the formulation is equally valid for predefined equidistant bins. FIG. 2 presents the general flow of the overall procedure. The aggregated supply and demand are first assigned to zone centroids, which are then used to calculate an imbalance density function using expression 8. Afterwards a multi-objective repositioning problem—as described in this section—is solved that minimizes the imbalance density and the repositioning VMTs.

First a general version is introduced that purely aims at minimizing the supply-demand imbalance density and the repositioning distance objectives without any restriction on zones—contrary to the traditional restriction of sending vehicles only from surplus to deficiency regions. Because of the ability to send vehicle to or from any region, it is referred to the formulation in the current section as RFR with regions and full flow (RFRRf). The next section will introduce formulation with constraints on origin and destination regions.

Consider a region based repositioning problem as defined in section 1.5. Let {x₁^{z}, x₂^{z}, . . . , x_{|Z|}^{z}} be the zone centroids. Instead of calculating the densities for customers and idle vehicles separately, one first accumulates the imbalances for each zone as given in expression 2, and then considers a combined imbalance density using weighted density formulation (expression 8). Thus, the multi-objective optimization problem for the RFRRf technique is given as:

$${min}_{δω , \hat{u}} \hat{f} ( δω ) , \hat{g} ( \hat{u} ) \qquad ( 10 a )$$

$$s . t . {\sum }_{i ∈ Z} {δω}_{i}^{+} - {\sum }_{i ∈ Z} {δω}_{i}^{-} = 0 \qquad ( 10 b )$$

$${\sum }_{j ∈ Z} {\hat{u}}_{ij} = {δω}_{i}^{-} ∀ i ∈ Z \qquad ( 10 c )$$

$${\sum }_{i ∈ Z} {\hat{u}}_{ij} = {δω}_{j}^{+} ∀ j ∈ Z \qquad ( 10 d )$$

$${δω}_{i}^{-} \leq \vert {V}_{i}^{+} \vert ∀ i ∈ Z \qquad ( 10 e )$$

$${δω}_{i}^{+} \leq {\sum }_{j ∈ Z} \vert {V}_{j}^{+} \vert ∀ i ∈ Z \qquad ( 10 f )$$

$${δω}_{i}^{+} \cdot {δω}_{i}^{-} \geq 0 ∀ i ∈ Z \qquad ( 10 g )$$

$$δω := {δω}^{+} - {δω}^{-}$$

$${δω}^{+} , {δω}^{-} ∈ \text{?}$$

$$\hat{u} ∈ \text{?}$$

$$\hat{g} ( \hat{u} ) = {\sum }_{i , j} {\hat{c}}_{ij} \text{?} \qquad ( 10 h )$$

$$\text{?} ( δω ) = F ( \text{?} ( \vert \text{?} \vert + \vert \text{?} \vert + \vert \text{?} \vert + {δω}_{i} ) k ( x , \text{?} ) , \text{?} \vert \text{?} \vert k ( \text{?} ) ) \qquad ( 10 i )$$

$$\text{?} \text{indicates text missing or illegible when filed}$$

where û is a flow matrix with each element ûᵢⱼ representing the number of idle vehicles repositioned from zone i to zone j, δω is a vector representing the overall change in the weight of a zone and

$$a = \frac{3}{π {h}^{2}} .$$

The changes in the zone weights δω is broken into positive δω⁺ and negative δω⁻ changes to the zone weights; thus, expression 10g makes sure that either of them are not simultaneously non-zero for each zone. C:=(ĉᵢⱼ)∈ [symbol] is the matrix of travelling costs between zone centroids. Expressions 10c and 10d guarantee that the total numbers of vehicles leaving a zone and entering other zones are in accordance with positive and negative changes to zone weights, respectively. Expression 10e ensures that the negative changes to a zone weight (number of vehicles leaving the zone) is restricted by the number of vehicles available in the zone. On the contrary, the main purpose of the constraint on δω⁺ in expression 10f is to prune the search space as the total increase in a zone weight cannot be more than the total available vehicles.

For calculating the difference between supply and demand densities in expression 10i, one can use the integral of squared deviation as it puts more importance to high imbalance values than other metrics as e.g. the integral of absolute deviation. Additionally, it significantly reduces the computational effort as described below:

$$\begin{matrix}\hat{f} ( δω ) = {a}^{2} \int [ {\sum }_{i ∈ Z} ( {\underbrace{\vert {R}_{i}^{+} \vert + \vert {V}_{i}^{+} \vert + \vert {V}_{i}^{γ} \vert - \vert {R}_{i}^{-} \vert}}_{= {ω}_{i}} & ( 11 ) \\ {+ {δω}_{i} ) k ( x , {x}_{i}^{z} , h ) ]}^{2} d Ω & \\ = {a}^{2} {\sum }_{i ∈ Z} {\sum }_{j ∈ Z} {\underbrace{( {ω}_{i} + {δω}_{i} ) ( {ω}_{j} + {δω}_{j} )}}_{constant for integration} \int k ( x , {x}_{i}^{z} , h ) k ( x , {x}_{j}^{z} , h ) d Ω & ( 12 )\end{matrix}$$

With the definition of matrix A∈ [symbol] (A)ᵢⱼ=∫k(x,xᵢ^{z}, h)k(x,xⱼ^{z},h)dΩ, the above equation can be written as (expression 13):

$$\begin{matrix}\hat{f} ( δω ) = {{a}^{2} ( ω + δω )}^{T} A ( ω + δω ) \\ = {a}^{2} ( {ω}^{T} A ω + ( 2 {ω}^{T} + {δω}^{T} ) A δω ) \\ = {a}^{2} ( 2 {ω}^{T} + {δω}^{T} ) A δω + Const\end{matrix}$$

The constant term Const=a²ω^{T}Aω can be ignored for the optimization problem. The major advantage of the formulation arises from the matrix A as for fixed zones it can be easily preprocessed using different numerical methods. One can use the simplest mid-point rule for this purpose. Thus, A is given as (expression 14):

$$A = [ \begin{matrix}{\sum }_{l , m} \hat{k} ( {x}_{1}^{z} , h ) \hat{k} ( {x}_{1}^{z} , h ) & ⋯ & {\sum }_{l , m} \hat{k} ( {x}_{1}^{z} , h ) \hat{k} ( {x}_{{n}_{z}}^{z} , h ) \\ ⋯ & ⋯ & ⋯ \\ {\sum }_{l , m} \hat{k} ( {x}_{{n}_{z}}^{z} , h ) \hat{k} ( {x}_{1}^{z} , h ) & ⋯ & {\sum }_{l , m} \hat{k} ( {x}_{{n}_{z}}^{z} , h ) \hat{k} ( {x}_{{n}_{z}}^{z} , h )\end{matrix} ] Δ x Δ y$$

where \hat{k}(xᵢ^{z},h) is the evaluation of the kernel function k(x,xᵢ^{z},h) on a discretised two dimensional grid with step sizes Δx and Δy.

Furthermore, another advantage of the formulation is that it is not even necessary to use the same bandwidth h for all zones or the complete day. According to the statistics of the zone, the bandwidth or reachability could be chosen differently. For example, for the outskirts of a city or low traffic zones, one can choose a larger bandwidth as the vehicle can pick up a customer from larger distances. Conversely, for the zones with lower traffic speeds (near the city centre), one can choose smaller bandwidths.

It should also be noted that as h approaches zero (no overlap of the kernel functions), A becomes the unity matrix and then expression 13 reduces to expression 15:

$$\hat{f} ( δω ) = {a}^{2} \text{?} {( {ω}_{i} + {δω}_{i} )}^{2}$$

$$\text{?} \text{indicates text missing or illegible when filed}$$

In this form the measurement of imbalance of a region is independent of the imbalances in other regions. Because of the multi-objective formulation in expression 10 and the square of zone weights in expression 15, the obtained repositioning problem will give higher preference to balancing the regions with higher imbalances—allowing the vehicles to be sent to far off regions as well. Secondly, since the bandwidth h is almost zero, the repositioned vehicle is assumed to pickup customers only from the regions where it is sent.

2.5 Repositioning Formulations with Zone Restrictions

Since the vehicle supply and demand densities are more general than the regional surplus and deficiency, the flow of vehicles in the RFRRf formulation was kept general—to and from all regions irrespective of local imbalances—to allow the minimization of overall density as much as possible. However, since one can use integral squared deviation to simplify and reduce the computational effort for the density objective expression 13, even small differences in the density objective could be overemphasized during the optimization process. Secondly, the regional demands vary significantly during night and day hours; for certain time of the day the majority of regions may not need additional vehicles. However, the RFRRf formulation would still try to distribute a surplus of available vehicles evenly throughout the city to decrease the imbalance (this can for example refer to night hours where all zones have vehicle surplus; balancing the surplus in these cases will generate additional VMT to equalize the imbalance density, but since there are already more vehicles than demand in the destinations of repositioning all customers could be served anyway). Both of these reasons could lead to increased repositioning of vehicles without a significant increase in the overall performance. Thus, this section presents formulations that restrict the flow of vehicles from certain regions based on their local imbalance to lower the above effects. One can put these restrictions in two steps:
1. Since the RFRRf formulation is general, it even allowed the repositioning of vehicles from deficiency zones to other zones. This will lower the short-term density, but may make even available vehicles in the deficient zones busy with repositioning; ultimately, leading to decreased performance gain. Thus, one can limit this effect by changing the constraint in expression 10e with the following expression 10e:

δωᵢ⁻≤min(max(0,ωᵢ),|Vᵢ⁺|)∀i∈Z

The above constraints restrict the negative changes in a zone (the outflow of vehicles) to be zero if the original zone weight is negative (i.e. deficient zone). Since this formulation only allows the outflow of vehicles from surplus (zones with positive weights), this formulation is referred to as RFRRp.
2. The RFRRp restricts the outflow from the deficiency to surplus zones, but there may still be excessive repositioning. The repositioning can happen from surplus to surplus zones to reduce the imbalance density. On the one hand, it may be beneficial to bring a higher number of vehicles to a zone than expected demand if demand and supply forecasts contain uncertainties; on the other hand this may cause unnecessary repositioning especially when majority of zones are not balanced. Therefore, the following RFRR approach restricts the overall formulation further by restricting the flow of vehicles to be only from surplus to deficiency zones. This would also simplify the formulation as the number of variables and the required matrix sizes in the RFRR formulation would decrease, as given below:

$${min}_{δω , \hat{u}} \hat{f} ( δω ) , \hat{g} ( \hat{u} ) \qquad ( 17 a )$$

$$s . t . {\sum }_{i ∈ Z} {δω}_{i} = 0 \qquad ( 17 b )$$

$${\sum }_{j ∈ {Z}^{-}} {\hat{u}}_{ij} = - {δω}_{i} ∀ i ∈ {Z}^{+} \qquad ( 17 c )$$

$${\sum }_{i ∈ {Z}^{+}} {\hat{u}}_{ij} = {δω}_{j} ∀ j ∈ {Z}^{-} \qquad ( 17 d )$$

$$0 \geq {δω}_{i} \geq - min ( {ω}_{i} , \vert {V}_{i}^{+} \vert ) ∀ i ∈ {Z}^{+} \qquad ( 17 e )$$

$$0 \leq {δω}_{i} \leq - {ω}_{i} ∀ i ∈ {Z}^{-} \qquad ( 17 f )$$

$$δω ∈ {ℤ}^{\vert Z \vert}$$

$$\hat{u} ∈ {ℤ}_{\geq 0}^{\vert {Z}^{+} \vert \times \vert {Z}^{-} \vert}$$

Notice the decrease in the size of flow variables matrix û and travelling costs matrix Ĉ from |Z|×|Z| in RFRRf and RFRRp to |Z⁺|×|Z⁻| for RFRR. The requirement for breaking the δω into positive and negative parts is also removed, as the changes in zone weights of deficiency and surplus zones could be only positive (expression 17f) and negative (expression 17e), respectively. Thus, the conditions of expressions 17c and 17d directly use δω to ensure that the changes in zone weights are consistent with the number of idle vehicles and furthermore prunes the solution space according to current weights. The condition of expression 17b guarantees the conservation of weight changes.

### 2.6 Implemented Optimization Approaches

The presented repositioning approach in expression 10 is a multi-objective optimization problem. The approach is presented first where the highest preference is given to the density objective. In the subsequent section the problem for finding the pareto fronts is formulated.

### Prioritized Balanced Density (PBD)

If the priority of objectives is known beforehand in a multi-objective optimization problem, the lexicographic method can be used. One major advantage of the method is that it gives a pareto optimal solution without a need of scaling the individual objectives. Usually in a lexicographic method, the problem is solved separately, first for the highest priority objective. Then, the already solved objective with the optimal values are put as constraints while solving the problem for the next objective. Since separate variables δω and û for the density and VMTs objectives, respectively, are used, one can first solve the optimization problem for \hat{f}(δω) completely separately for optimal δω and then put these optimal values as constraints on δω when solving for ĝ(û).

### Normalized Weighted Sum

The weighted sum method is a multi-objective method, where the individual objectives are multiplied by constant weights for relative importance. The assigned weights help to move over pareto front solutions. However, as the units and the magnitude of the individual objectives may vary for different problem instances, it requires a meaningful scaling of the individual objectives. In the present disclosure one can use the approach of scaling the objectives using nadir and utopian values. Thus, the multi-objective function in expression 17a can be written as (expression 18):

$${min}_{δω , \hat{u}} γ \frac{\hat{f} ( δω ) - {\hat{f}}_{utopia}}{{\hat{f}}_{nadir} - {\hat{f}}_{utopia}} + ( 1 - γ ) \frac{\hat{g} ( \hat{u} ) - {\hat{g}}_{utopia}}{{\hat{g}}_{nadir} - {\hat{g}}_{utopia}}$$

where γ∈[0,1) is a constant weight for relative importance of balanced density and distance objectives. The value of γ cannot be perfectly 1 as this make the repositioning formulation to only have density as the objective, leading to multiple optimal solutions with random distance objective and flow variables. γ=0, on the other hand, always has the unique solution of no repositioning. An MoD service operator can choose between different values of γ according to the willingness to invest in the extra VMTs for repositioning.

The utopian and nadir points are obtained from the pareto optimal set of solutions. This set is usually obtained by optimizing the individual objectives with the original constraints. The lower bounds from the set for the individual objectives form the utopian point and the upper bounds forms the nadir point. The lower bound is called utopian because generally such a point for an objective is not achievable while considering multiple objectives.

In the current problem formulation, it is sufficient to consider two extreme pareto solutions for finding the utopian and nadir points. The distance objective ĝ(û) results in the minimum when there is no movement, i.e. no repositioning vehicles: ĝᵤₜₒₚᵢₐ=0. This solution results in the worst density objective along the Pareto front and is equal to the initial value i.e. \hat{f}_{nadir}=\hat{f}ᵢₙᵢₜᵢₐₗ. Similarly, the other extreme pareto optimal solution with minimum density objective is produced when one uses the PBD approach described in the previous section. Therefore, \hat{f}_{pbd} and ĝ_{pbd} denote the objective values of density and distance objective after solving with PBD approach, then expression 18 is given as expression 19:

$${min}_{δω , \hat{u}} γ \frac{\hat{f} ( δω ) - {\hat{f}}_{pbd}}{{\hat{f}}_{initial} - {\hat{f}}_{pbd}} + ( 1 - γ ) \frac{\hat{g} ( \hat{u} )}{{\hat{g}}_{pbd}}$$

### 2.7 Long-Term Key Performance Indicator (KPIs)}

Generally, because of the dynamic nature of RH services, the benefits of a repositioning decision cannot be evaluated till the realization of the actual customer demand in the system. For a repositioning algorithm it is usually difficult to evaluate the long-term impacts of a decision. Therefore, the goal is to empirically show the correlations between various KPIs and long-term repositioning performance. Following the same zone definitions as in section 1.5, one can introduce the following KPIs:

$${K}_{\geq 0} = {\int }_{{Ω}^{+}} p ( x ; ρ ) d Ω {Ω}^{+} = \{ x ∈ Ω : p ( x ; ρ ) \geq 0 \} \qquad ( 20 )$$

$${K}_{\leq 0} = {\int }_{{Ω}^{-}} p ( x ; ρ ) d Ω {Ω}^{-} = \{ x ∈ Ω : p ( x ; ρ ) \leq 0 \} \qquad ( 21 )$$

$$p ( x ; ρ ) = \frac{3}{π {h}^{2}} {\sum }_{i = 1}^{{n}_{s}} {ρ}_{i}^{z} k ( x , {x}_{i}^{z} , h ) ( Spatial density of imbalance )$$

where ρᵢ^{z}∈{ωᵢ,ωᵢ+δωᵢ} can be the pre- or post-repositioning weight for zone i∈Z. K_{≥0} and K_{≤0} correspond to the total amount of vehicle surplus and the total amount of vehicle deficiency in the whole operating area, respectively. In the present disclosure, a mid-point rule can be used for calculating the integrals.

### 3. Summary

The present disclosure provides performance improvements of MOD services. One aspect is the introduction of a reachability function-based density method that coherently links regions within the operating area while taking into account the sizes and proximity of individual regions. The reachability function defines the relation of one region with the surrounding area. The density term can be applied to any regional measurement that is expected to affect other regions and the overall operational area; thus, the density-based measurement can significantly improve the performance of any future MOD contribution that uses measurement based on inter-regional relations.

A further aspect is the application of the density method to the repositioning of idle vehicles in the MOD services. First the regional vehicle imbalances are measured using customer forecasts and a forecast of available vehicles (note that vehicles, which are forecasted to be idle soon, can also be considered)—by assigning a positive or negative regional weight according to the surplus or deficiency of vehicles, respectively. Next, a 2D linear kernel or vehicle reachability function (VRF), representing the area from which a vehicle at the centre of the region can pick up a customer, is used as the reachability function inside the above-mentioned density method. Then, a multi-objective repositioning problem is formulated, where the importance of the imbalance density has to be optimized against the repositioning VMTs. This whole procedure is analogous to the balancing of weights inside a weighted KDE, where the imbalance density can be looked at as 2D heat-map of the vehicle imbalance. Agent-based simulations can be used to quantify the benefits of the developed approaches on open-source New York Taxi Data, which shows a remarkable improvement over state-of-the-art repositioning method for one week of simulation.

Finally, the presented density-based approach can pave the way for more advanced operational strategies. Even though pre-defined regions can be used as means for a computationally feasible optimization problem in the repositioning, the idea of VRF-based vehicle imbalance will show potential in combination with more refined forecast granularity and AI-based algorithms. The development of instant repositioning awards can help AI-based (and non-myopic dynamic programming) algorithms because it is generally difficult to evaluate the benefits of repositioning decisions at a given time: the customers, which could only be served due to the vehicle repositions, are not known at the decision time. By showing correlations of served customers and density based KPIs, these KPIs can be used to reward and therefore compare different repositioning options without an actual realization.

While the foregoing is directed to examples of the disclosure, other and further examples of the disclosure may be devised without departing from the basic scope thereof, and the scope thereof is determined by the claims that follow.

1.-14. (canceled)

15. A method for operating a fleet of vehicles, comprising:
providing an operating area of the fleet of vehicles, wherein
the operating area is divided into a plurality of regions;
determining, for each region, an imbalance based on a vehicle supply and a vehicle demand of the region;
converting the imbalances of each region into respective imbalance densities; and
performing fleet optimization based on the respective imbalance densities to reduce an overall vehicle imbalance in the operating area.

16. The method of claim 15, wherein the imbalance of a region is determined by subtracting the vehicle supply from the vehicle demand, or by subtracting the vehicle demand from the vehicle supply.

17. The method of claim 15, wherein the vehicle demand of a region is determined based on forecast information.

18. The method of claim 15, wherein the converting the imbalances of each region into respective imbalance densities uses a 2D Kernel function.

19. The method of claim 15, wherein the fleet optimization is based on multi-objective optimization, wherein
the fleet optimization is based on a lexicographic method or a weighted sum method.

20. The method of claim 15, further comprising:
applying the method to a relocation of one or more vehicles of the fleet of vehicles from their present region to another region based on the fleet optimization.

21. The method of claim 15, further comprising:
implementing one or more flow restrictions.

22. The method of claim 21, wherein the one or more flow restrictions are selected from the group consisting of:
limiting a relocation of vehicles from vehicle deficient regions to vehicle surplus regions; and
limiting a relocation of vehicles from vehicle surplus regions to other vehicle surplus regions.

23. The method of claim 15, further comprising:
determining a travel path for at least one vehicle of the fleet of vehicles based on the fleet optimization.

24. The method of claim 23, further comprising:
navigating and/or controlling the at least one vehicle according to the determined travel path.

25. The method of claim 15, wherein the vehicles of the fleet of vehicles are configured for autonomous driving and/or manual driving.

26. A machine-readable medium comprising instructions executable by one or more processors to implement the method for operating a fleet of vehicles according to claim 15.

27. A system for operating a fleet of vehicles, comprising:
one or more processors; and
a memory coupled to the one or more processors and comprising instructions executable by the one or more processors to configure the system to:
provide an operating area of the fleet of vehicles, wherein
the operating area is divided into a plurality of regions;
determine, for each region, an imbalance based on a vehicle supply and a vehicle demand of the region;
convert the imbalances of each region into respective imbalance densities; and
perform fleet optimization based on the respective imbalance densities to reduce an overall vehicle imbalance in the operating area.

28. The system of claim 27, wherein the system is a server of a Mobility Service Provider.
